(19) United States
(12) Patent Application Publication
(10) Pub. No.: US 2015/0210915 A1
(43) Pub. Date: Jul. 30, 2015

(54) SELF-LUBRICATED WATER-CRUDE OIL HYDRATE SLURRY PIPELINES

(71) Applicant: FLUOR TECHNOLOGY CORPORATION, Aliso Viejo, CA (US)

(72) Inventor: Baha Elsayed ABULNAGA, Bellingham, WA (US)

(21) Appl. No.: 14/607,847

(22) Filed: Jan. 28, 2015

Related U.S. Application Data
(60) Provisional application No. 61/932,593, filed on Jan. 28, 2014.

(51) Int. Cl. C09K 8/52

(52) U.S. Cl. CPC C09K 8/52; C09K 2208/28; C09K 2208/22

(57) ABSTRACT

Systems and methods for reducing friction loss in pipeline transmission of crude oil-hydrate slurry mixtures are presented in which the crude oil-hydrate slurry mixture is formed from water, methane, and crude oil at proportions that support self-lubrication above a critical transport velocity at Arctic temperature conditions.

This application claims the benefit of priority to U.S. provisional application having Ser. No. 61/932593, filed on Jan. 28, 2014.

### FIELD OF THE INVENTION

The field of the invention is methods, systems, and devices for reduction of friction losses associated with the transport of mixed fluids comprising hydrates and hydrocarbons through pipelines in a slurry form, especially as it relates to transport of such fluids in cold environments (e.g., arctic environment).

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Natural gas and oil production in the Arctic, especially in deep sea fields has received significant attention as Arctic resources are expected to contain more than 6 billion barrels of oil equivalent of recoverable oil in the form of hydrates of natural gas. In most, or all of the Arctic formations, natural gas is present in the form of a gas hydrate, typically admixed with crude oil. Since processing is often not feasible on site, the natural gas-crude oil mix requires transport, typically via pipelines to an offshore facility. However, due to the low temperatures in the Arctic environment, hydrates can build up and wax crystals can form on the inside wall of the pipeline, which can substantially increase friction along the pipeline, and with that decreases the pumping efficiency and economics.

Conceptually two different methods have been deployed to reduce friction: Prevention of agglomeration and ‘cold technology’. Prevention of agglomeration uses dispersants or anti-agglomeration agents such as alcohols to reduce or prevent agglomeration of hydrate crystals. Unfortunately, most of the required chemicals are relatively expensive and often tend to be less effective for pipelines in excess of 25 km. The ‘cold technology’ ultimately provides a natural gas-crude oil mixture in slurry form with a relatively low water content. While ‘cold technology’ allows controlled slurry formation at moderate temperatures, crude oil at Arctic temperature conditions has typically a very high viscosity and thus impedes flow. Thus, while “cold technology” is suitable for warmer environments, it is generally not suitable for Arctic deployment where transport temperatures are often below 10° C.

More recently, some efforts have been made to improve the efficiency of hydrocarbon transport. For example, U.S. Pat. No. 7,958,939 teaches advantages of providing a hydrate slurry at high water cut (>50 vol %, typically in combination with anti-agglomerants), typically prepared by addition of water to so prepare a pumpable hydrate slurry. Specific temperature and pressure controls are then employed at various water content to maintain the slurries pumpable. As before, however, conditions reported in the '939 patent are predominantly at relatively high temperatures (e.g., 60° F.). Moreover, the '939 patent fails to recognize the possibility of self-lubrication using proper hydrocarbon hydrate mixtures with water at critical velocities to so achieve such self-lubrication.

Other efforts have been made to reduce friction in slurries of sand, hydrocarbons, and water using a self-lubricated transport mechanism. For example, Joseph et al. (Journal of Fluid Mechanics, vol. 386, Issue 01, p. 127-148: Self-lubricated transport of bitumen froth) discusses a transport mechanism by a lubricating layer of water along the pipeline. Joseph discloses that the water present in the froth is released at the pipe wall and forms a lubricating layer of water, which allows bitumen froth pumping at reduced pressures. Joseph further discusses that the bitumen froth should be pumped at a critical speed for froth lubrication. Notably, Joseph et al. do not include gas hydrates in their systems. Additionally, Joseph's sand-hydrocarbon-water pumping system yet again was limited to relatively high (e.g., 35 to 55° C.) temperatures and as such would likely not work as intended at Arctic temperatures.

Similarly, Sanders et al. (The Canadian Journal of Chemical Engineering, Volume 82, August 2004; pp 735-742: Factors governing friction losses in self-lubricated transport of bitumen froth: 1. Water release) discusses the importance of froth water content, superficial velocity, and froth temperature. In addition, Sanders discusses the water content of the froth affects pipeline pressure gradient for self-lubricated bitumen froth flow. However, and as noted before, both Joseph and Sanders limited their studies to bitumen froth. The bitumen is present at higher temperature (e.g., 50° C.) and is typically extracted by hot water extraction processes. As such, the models and observations of Joseph and Sanders fail to apply to gas hydrates and/or consider cold environments with hydrates in the mixed fluid.

Therefore, there is still a need for improved compositions, systems, and methods for reducing friction losses associated with transportation of hydrocarbon fluid through pipelines, especially where such fluids comprise hydrates and are transported under low-temperature (e.g., Arctic) conditions.

### SUMMARY OF THE INVENTION

The inventive subject matter is drawn to various plants, systems, and methods of reducing friction loss in pipelines for transport of hydrates where a crude oil-hydrate slurry mixture is formed at proportions that support self-lubrication by formation of a tiger wave or low viscosity film on an internal surface of the pipeline above a critical transport velocity at the transport temperature (typically below 10° C.).

In one aspect of the inventive subject matter, the inventor contemplates a method of reducing friction losses associated with the transport of a hydrocarbon fluid. In especially preferred methods, a crude oil-hydrate slurry mixture is formed that includes a crude oil fraction and a water-based hydrocarbon hydrate slurry, wherein the hydrate slurry comprises a gas fraction (e.g., containing at least 70 mol % methane) and a water fraction at a first ratio, and wherein the crude oil-hydrate slurry mixture comprises the hydrate slurry and the crude oil fraction at a second ratio. In another step, the crude oil-hydrate slurry mixture is delivered into a pipeline and the transport velocity of the crude oil-hydrate slurry mixture is increased at a transport pressure and transport temperature to such a velocity that water separates from the crude oil-hydrate slurry mixture to so allow for the formation of form a tiger wave or a low viscosity film on an internal surface of the pipeline.

While not limiting to the inventive subject matter, it is preferred that the crude oil-hydrate slurry mixture is formed in a mixing device that combines the crude oil fraction and the water-based hydrate slurry at the second ratio, and/or that the water-based hydrate slurry is formed in a reactor that combines the gas fraction and water at a pressure of at least 50 bar and a temperature of between −6 to 10 ° C. Most typically, the first ratio is between 15:1 and 1:1, and the second ratio is between 5:1 and 1:1. In most cases, contemplated methods also include a step of separating a well hydrocarbon fluid (e.g., from a subsea well) into the crude oil fraction and the gas fraction.

Suitable velocities will be at least 1 m/s or at least 2.5 m/s where the crude oil-hydrate slurry mixture is transported through the pipeline at a temperature of below 10° C., and the crude oil-hydrate slurry mixture is preferably formed under water (e.g., using ocean water to form the water-based hydrate slurry). All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Viewed form a different perspective, the inventor also contemplates a hydrocarbon fluid transport system for reducing friction losses associated with transport of a hydrocarbon fluid. Preferred systems will typically include a separator that receives and separates a (e.g., subsea) well hydrocarbon fluid into a gas fraction and a crude oil fraction. A reactor may then be fluidly coupled to the separator to receive the gas fraction and to mix the gas fraction with water at a first ratio to form a water-based hydrate slurry. A mixing device will then combine the water-based hydrate slurry with the crude oil fraction at a second ratio to form a crude oil-hydrate slurry mixture. Contemplated systems will also include a pump that pumps the crude oil-hydrate slurry mixture through a pipeline, while a control circuit adjusts the pump rate of the pump such that the crude oil-hydrate slurry mixture achieves at the transport temperature (typically below 10° C.) a velocity (e.g., at least 1 m/s, or at least 2.5 m/s) at which water separates from the crude oil-hydrate slurry mixture to form a tiger wave or a low viscosity film on an internal surface of the pipeline.

In further preferred aspects, the separator is a gravity separator, and/or contemplated systems will further comprise a compressor that is configured to compress the gas fraction to a pressure suitable for gas hydrate formation. While not limiting to the inventive subject matter, the reactor will typically combine the gas fraction with ocean water to so form the water-based hydrate slurry. Thus, contemplated systems will typically be coupled to a subsea platform or other subsea foundation.

Consequently, the inventors also contemplate a crude oil-hydrate slurry mixture that comprises a water-based hydrate slurry and a crude oil fraction. The water-based hydrate slurry will preferably have a gas fraction and water at a ratio of between 15:1 and 1:1, wherein the gas fraction comprises at least 70 mol % methane, while the water-based hydrate slurry and the crude oil fraction are preferably present in the crude oil-hydrate slurry mixture at a ratio of between 5:1 and 1:1. Thus, the first and second ratios in contemplated crude oil-hydrate slurry mixtures are such that the crude oil-hydrate slurry mixture forms a tiger wave or a low viscosity film on an internal surface of a pipeline when the crude oil-hydrate slurry mixture is pumped through the pipeline at or above a critical velocity. Most typically, the water comprises ocean water, and/or water is present in the crude oil-hydrate slurry mixture in an amount of at least 50 wt %.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an exemplary photograph of tiger wave formation in a flowing volume of bitumen froth in a transparent pipe section with an opaque water layer at the pipe wall being interrupted by waves peaks of bitumen.

FIG. 2 is a schematic illustration of a transport system for crude oil-hydrate slurry mixtures according to the inventive subject matter.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventor has discovered that friction losses in pipelines for transport of hydrates can be substantially reduced where the hydrates are transported in a crude oil-hydrate slurry. Most notably, the inventor also discovered that such mixtures can be formed and maintained at temperatures and pressures that would otherwise lead to various difficulties with respect to wax and hydrate formation (e.g., at very cold environments such as Arctic environments). For example, while recent advances in deep sea exploration has made available large reserves of oil and gas at well temperatures of typically 40-80° C., the surrounding sea water temperature is often in the range of −2 to +4° C. Thus, without insulation of the pipeline and/or addition of chemicals to prevent hydrate formation/agglomeration, the well fluid will relatively quickly decrease in temperature reaching the Wax Appearance Point (WAP, typically in the range of 20-40° C.) and with further decrease in temperature hydrate formation temperature (typically in the range of 10-20° C.). Such decrease is particularly likely in pipelines having a length of at least 500 m, more typically at least 1 km, and most typically at least 2 km (e.g., 2-5 km, or even longer). The recitation of ranges of values herein is merely intended to serve as a shorthand method of referring individually to each separate value falling within the range. Unless otherwise indicated herein, each individual value is incorporated into the specification as if it were individually recited herein. Moreover, all ranges set forth herein should be interpreted as being inclusive of their endpoints, and open-ended ranges should be interpreted to include commercially practical values.

To overcome problems associated with temperature drop and the associated wax and hydrate formation in the well hydrocarbon fluid, the inventor contemplates a process in which hydrate formation is allowed to proceed from a gas fraction of the well hydrocarbon fluid in a controlled manner to so form a water-based hydrocarbon hydrate slurry that is subsequently combined with a crude oil fraction of the well hydrocarbon fluid. At the appropriate ratios, it should be appreciated that the so formed crude oil-hydrate slurry mixture is not only suitable for pipeline transport, but also has a composition that allows for partial water separation from the slurry mixture above a critical velocity at low-temperature conditions (e.g., −2 to 10° C.) to so form a tiger wave or a low viscosity film on an internal surface of the pipeline. Such water separation is thought to lubricate the pipeline by the water preferentially locating to the inner surface of the pipeline. Viewed form a different perspective, contemplated crude oil-hydrate slurry mixtures will support self-lubrication by formation of a tiger wave or low viscosity film on an internal surface of the pipeline above a critical transport velocity at the transport temperature (typically below 10° C., e.g., −4 to 9° C.).

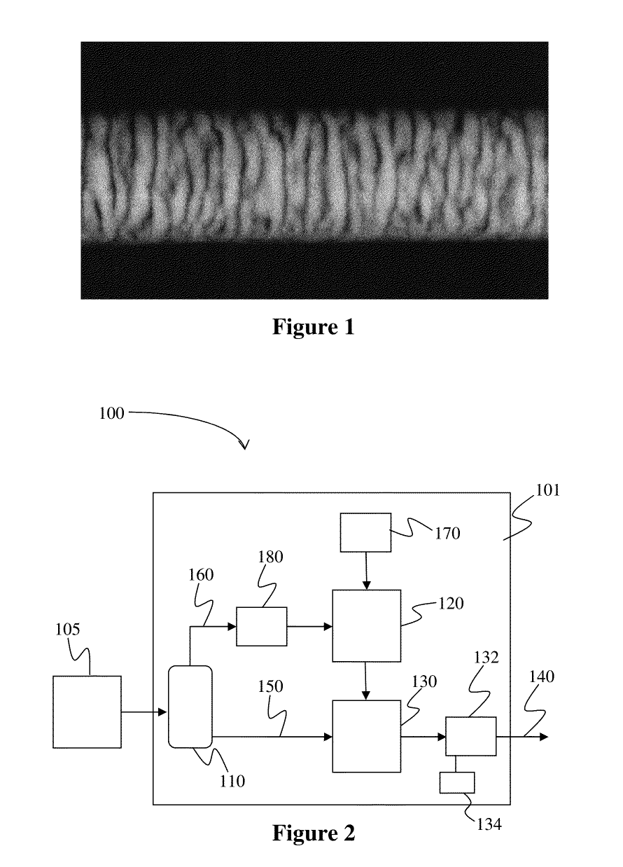

The term “tiger wave” as used herein refers to the phenomenon of water release from a water-containing slurry where at least some of the water accumulates at the inner wall of a pipeline and where portions of that water layer is interrupted or thinned by waves in a core-annular flows of a hydrophobic fluid (e.g., crude oil or crude oil mixtures). As such, when viewed through a transparent pipeline, the waves of the hydrophobic core-annular flow will appear in the water layer in a tiger stripe pattern as exemplarily shown in FIG. 1. Here, a tiger wave formation can be seen in a flowing volume of bitumen froth with an opaque water layer at the pipe wall being interrupted by waves peaks of bitumen. In such typical example, about 20-30 wt % of all water originally in the moving fluid is located around the inner wall of the pipeline. Likewise, the term “low viscosity film” refers to layer of water that separates from a slurry mixture to form a film that has a viscosity that is less than the individual viscosities of the hydrocarbon phase and the crude oil-hydrate slurry mixture. It should be noted, however, that tiger waves may touch from time to time the steel pipe and cause some oil to stick to the inner surface of the steel pipeline.

For example, separation of the well hydrocarbon fluid can be performed in various manners known in the art, and the particular nature of separation is not limiting to the inventive subject matter. However, most typically separation is performed using a gravity separator. Depending on the specific composition of the well hydrocarbon fluid, the gas fraction or the crude oil fraction originating from the separator may be in excess of a ratio that is deemed suitable for the formation of the water-based hydrate slurry and/or crude oil-hydrate slurry mixture. In such case, it is contemplated that the excess gas fraction or crude oil fraction may be stored (e.g., temporarily) in a surge tank, or may be otherwise transported to a suitable point of use or transport (e.g., riser, compressor, floating production platform, floating or seabed storage etc.).

It is generally contemplated that the systems and methods described herein are particularly suitable for deep ocean hydrate fields such as those found in the Arctic where the gases are first separated from a well hydrocarbon fluid to form a gas fraction. The gas fraction is then compressed to a pressure suitable for hydrate formation at the temperature that is substantially ambient temperature at the subsea environment. For example, suitable pressures will be in some aspects at least 25 bar, in some aspects at least 30 bar, in some aspects at least 50 bar, in some aspects at least 70 bar, and in some aspects at least 90 bar, depending on the particular temperature. In this context it should be noted that higher temperatures generally results in higher pressures for hydrate formation at the same level of salinity. On the other hand, an increase in salinity will typically result in hydrate formation at lower temperatures.

Therefore, and assuming hydrate formation is at Arctic subsea temperatures (e.g., −2 to 4° C.) most C1-C3 hydrocarbon components, and especially methane will be encapsulated in water molecules or form stable hydrates at a pressure of at least 30 bar, in some aspects at least 50 bar, and in other aspects at least 90 bar. However, it should be noted that higher temperatures are also contemplated and include those generally below 15° C. (e.g., between 10-15° C., or between 18-12° C., or between 5-15° C., or between 5-10° C., or between 0-10° C.). Consequently, hydrate formation is also contemplated at significantly higher pressures (e.g., between 30-50 bar, or between 50-80 bar, or between 80-120 bar, or between 120-170 bar, etc.). Concurrently or subsequently, water is added to form a water based slurry. Most typically, it should be noted that the water will be ocean water. However, water with less salinity is also deemed suitable, which has the added benefit of reducing the pressure required for hydrate formation. Of course, it should be noted that the nature of the hydrocarbon in the gas fraction may vary to some degree and will include C1-C3 hydrocarbons. However, in most typical aspects, the hydrocarbon will be predominantly (e.g., at least 50 mol %, or at least 70 mol %, or at least 80 mol %) methane.

With respect to the weight ratio between water and gas fraction in the slurry, it is generally contemplated that the gas will have a larger fraction than the water. Therefore, suitable ratios include those between 15:1 and 1:1, or between 15:1 and 5:1, or between 10:1 and 1:1, or between 10:1 and 5:1, or between 5:1 and 1:1. Additionally, it is contemplated that the average particle size of the hydrate may vary considerably. For example, average particle size may be between 5-50 μm (e.g., between 10-30 μm or 20-40 μm), or between 10-200 μm (e.g., between 10-50 μm or 50-150 μm), or between 50-500 μm (e.g., between 100-300 μm or 200-400 μm), or even larger. For example larger hydrate particle sizes include 0.5-2 mm, or 2-5 mm, or even larger. However, it is generally noted that the particle size is such that agglomeration to particle sizes that disturb a tiger wave or formation of a low-viscosity layer does not or only minimally occur.

Formation of the water-based hydrate slurry is most preferably performed in a reactor that is typically collocated with the hydrocarbon production well. Suitable reactors include those with static or moving mixing implements and other reactor internals appropriate for hydrate formation Likewise, it is generally preferred that additional water can be added to the same reactor to so form the water-based hydrate slurry. Thus, and viewed from a different perspective, suitable reactors include batch reactors and continuous reactors to form the water-based hydrate slurry. With respect to the water it should be appreciated that the water can be ocean water or water with reduced (or in some cases increased) salinity, which may be provided from the environment or a holding tank. Of course, it should be recognized that the water may be pre-processed (e.g., filtered, desalinated, mixed with one or more additives to reduce agglomeration) as best suitable.

The water-based hydrocarbon hydrate slurry is then mixed with at least some of the crude oil fraction that was separated from the well hydrocarbon fluid but forms an important concentration of the mixture (e.g., 50% by weight), or at least the minimum amount required to achieve self-lubrication. For example, suitable ratios of the water-based hydrocarbon hydrate slurry and the crude oil fraction is between 5:1 and 1:1, or in some cases between 3:1 and 1:1, or in some cases between 5:1 and 3:1, or in some cases between 2:1 and 1:1. Combination of the water-based hydrocarbon hydrate slurry with the crude oil fraction to form the crude oil-hydrate slurry mixture can be achieved in numerous manners using static or dynamic mixers, or simply via combination of the two products into a single vessel or conduit.

The so obtained crude oil-hydrate slurry mixture is fed into a transport pipeline and pumped until the mixture exceeds a critical velocity (i.e., the self-lubrication velocity). Of course, it should be appreciated that the critical velocity may vary substantially and will at least in part depend on the composition and ratios in the crude oil-hydrate slurry mixture, and the diameter of the pipeline. However, it should be recognized that the choice of suitable critical velocities can be determined using predictive algorithms and/or experimental data. For example, the crude oil-hydrate slurry mixture can be pumped through the pipeline (e.g., having diameters between 2 and 50 inches, and more typically between 5 and 25 inches) at velocities ranging between 0.5 to 5 m/s, depending on temperature and other factors.

At the self-lubrication velocity a portion of the water separates from the slurry mixture and attaches itself or collocates to the inner wall of the pipe thereby forming a low viscosity layer. As a result, the overall friction losses to pump the hydrate slurry will significantly drop compared to pumping straight crude oil. In most cases using contemplate crude oil-hydrate slurry mixtures, the minimum superficial velocity for self-lubrication is at about 1.0 to 2.5 m/s, depending on the particular temperature. Therefore, suitable pump rates will be at least 0.8 m/s, or at least 1.0 m/s, or at least 1.4 m/s, or at least 1.8 m/s, or at least 2.2 m/s, or at least 2.5 m/s. Furthermore, in most instances, the pressure in the pipeline will be at least 25 bar, in some aspects at least 30 bar, in some aspects at least 50 bar, in some aspects at least 70 bar, and in some aspects at least 90 bar. Temperatures for pipeline transport will generally be relatively low (e.g., at or below 15° C.) and in most instances between −4° C. and below 12° C., or between −4 ° C. and below 10° C., or between −2° C. and below 10° C.

FIG. 2 schematically illustrates an exemplary hydrocarbon fluid transport system for reducing friction losses. In typical configurations and methods, the system 100 comprises a separator 110 that is fluidly coupled to a well 105 to so receive a feed hydrocarbon fluid. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. In separator 110, the feed hydrocarbon fluid is separated into a crude oil fraction 150 and a gas fraction 160. The gas fraction 160 is compressed in compressor 180, if needed, to achieve a pressure at which hydrate formation occurs at the given temperature (e.g., between −6 to 10° C., or between −4 to 6° C., or between −2 to 4° C.) and mixed with water from water source 170 in a first ratio to thereby form water-based hydrate slurry in reactor 120. Additional water can be added from the water source as already noted above. The water-based hydrate slurry is then mixed with the crude oil fraction 150 in mixing device 130 at a second ratio to so form the crude oil-hydrate slurry mixture. The crude oil-hydrate slurry mixture pumped through the pipeline 140 by a pump 132 that is fluidly coupled with the pipeline 140. A control circuit 134 is coupled to the pump 132 and configured to adjust the pump rate of the pump 132 such that the crude oil-hydrate slurry mixture achieves at the transport temperature (e.g., between −2 and 10° C.) a velocity at which water separates from the crude oil-hydrate slurry mixture to form a tiger wave and/or to form a low viscosity film on the internal surface of the pipeline. Most typically, contemplated systems are installed on the seabed and will therefore use a foundation 101 or other anchoring structure for one or more of the components.

In some embodiments, the separator separates the feed hydrocarbon fluid into a gas fraction and a crude oil fraction by gravity. In other embodiment, the separator separates the gas fraction and the crude oil fraction by physical separation devices (e.g., centrifugal, settling vanes, weirs, coalescing filters, etc.), chemical separation, and/or heat. Most typically, however, the separator is a conventional hydrocarbon/gas separator as commonly used in the art. Depending on the particular location, manner of extraction, and stage/age of the extraction, the chemical composition of the gas fraction will vary considerably. However, in most cases methane will be the predominant hydrocarbon in the gas fraction. For example, the gas fraction may comprise at least 70 mol %, and more typically at least 80 mol %, and even more typically at least 90 mol % methane. In other embodiments, the gas fraction comprises at least 50 mol % methane. The remainder of the gas fraction will then be higher hydrocarbons (C2-C5), CO2, and sulfurous species to a lesser extent.

In generally contemplated embodiments, the system also comprises a control circuit configured to adjust the first and second ratios such that the crude oil-hydrate slurry mixture forms a tiger wave or a low viscosity film on an internal surface of a pipeline at or above a critical velocity. In some embodiments, the control circuit is coupled with a sensor detecting the viscosity or velocity of the crude oil-hydrate slurry mixture pumped through the pipeline. Once received the information of the viscosity or velocity of the crude oil-hydrate slurry mixture from the sensor, the control unit can adjust the first and second ratios to reduce the further friction loss associated with transport of the crude oil-hydrate slurry mixture.

While the system discussed herein is preferably located in a subsea environment (such as the Arctic deep sea environment at a depth of at least 1,000 m), it should be noted that contemplated systems may also be located in other low-temperature environments, including above-ground environments at a low temperature.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, as used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. Where the specification claims refers to at least one of something selected from the group consisting of A, B, C . . . and N, the text should be interpreted as requiring only one element from the group, not A plus N, or B plus N, etc.

What is claimed is:

1. A method of reducing friction losses associated with the transport of a hydrocarbon fluid, comprising:
forming a crude oil-hydrate slurry mixture that comprises a crude oil fraction and a water-based hydrocarbon hydrate slurry;
wherein the water-based hydrocarbon hydrate slurry comprises a gas fraction and a water fraction at a first ratio, and wherein the crude oil-hydrate slurry mixture comprises the water-based hydrocarbon hydrate slurry and the crude oil fraction at a second ratio;
delivering the crude oil-hydrate slurry mixture into a pipeline and increasing transport velocity of the crude oil-hydrate slurry mixture at a transport pressure and transport temperature to a velocity at which water separates from the crude oil-hydrate slurry mixture to form a tiger wave or a low viscosity film on an internal surface of the pipeline.

2. The method of claim 1 wherein the crude oil-hydrate slurry mixture is formed in a mixing device that combines the crude oil fraction and the water-based hydrate slurry at the second ratio.

3. The method of claim 1 wherein the water-based hydrate slurry is formed in a reactor that combines the gas fraction and water at a pressure of at least 50 bar and a temperature of between −6 to 10° C.

4. The method of claim 1 wherein the first ratio is between 15:1 and 1:1 and wherein the second ratio is between 5:1 and 1:1.

5. The method of claim 1 wherein the gas fraction comprises at least 70 mol % methane.

6. The method of claim 1 further comprising a step of separating a well hydrocarbon fluid into the crude oil fraction and the gas fraction.

7. The method of claim 1 wherein the velocity is at least 1 m/s and wherein the crude oil-hydrate slurry mixture is transported through the pipeline at a temperature of below 10° C.

8. The method of claim 1 wherein the velocity is at least 2.5 m/s and wherein the crude oil-hydrate slurry mixture is transported through the pipeline at a temperature of below 10° C.

9. The method of claim 1 wherein the step of forming the crude oil-hydrate slurry mixture is performed under water.

10. The method of claim 1 wherein the water-based hydrate slurry is formed using ocean water.

11. A hydrocarbon fluid transport system for reducing friction losses associated with transport of a hydrocarbon fluid, comprising:
a separator configured to receive and separate a well hydrocarbon fluid into a gas fraction and a crude oil fraction;
a reactor fluidly coupled to the separator and configured to receive the gas fraction and further configured to mix the gas fraction with water at a first ratio to form a water-based hydrate slurry;
a mixing device configured to combine the water-based hydrate slurry with the crude oil fraction at a second ratio to form a crude oil-hydrate slurry mixture;
a pump coupled to the mixing device, wherein the pump is configured to pump the crude oil-hydrate slurry mixture through a pipeline; and
a control circuit configured to adjust a pump rate of the pump such that the crude oil-hydrate slurry mixture achieves at a transport temperature a velocity at which water separates from the crude oil-hydrate slurry mixture to form a tiger wave or a low viscosity film on an internal surface of the pipeline.

12. The hydrocarbon fluid transport system of claim 11 wherein the separator is a gravity separator.

13. The hydrocarbon fluid transport system of claim 11 further comprising a compressor that is configured to compress the gas fraction to a pressure suitable for gas hydrate formation.

14. The hydrocarbon fluid transport system of claim 11 wherein the reactor is configured to combine the gas fraction with ocean water to so form the water-based hydrate slurry.

15. The hydrocarbon fluid transport system of claim 11 wherein the system is coupled to a subsea foundation.

16. The hydrocarbon fluid transport system of claim 11 wherein the velocity is at least 1 m/s where the transport temperature is below 10° C.

17. The hydrocarbon fluid transport system of claim 11 wherein the velocity is at least 2.5 m/s where the transport temperature is below 10° C.

18. A crude oil-hydrate slurry mixture, comprising:
a water-based hydrate slurry and a crude oil fraction;
wherein the water-based hydrate slurry comprises a gas fraction and water at a ratio of between 15:1 and 1:1, and wherein the gas fraction comprises at least 70 mol % methane;
wherein the water-based hydrate slurry and the crude oil fraction are present in the crude oil-hydrate slurry mixture at a ratio of between 5:1 and 1:1; and
wherein the first and second ratios are such that the crude oil-hydrate slurry mixture forms a tiger wave or a low viscosity film on an internal surface of a pipeline when the crude oil-hydrate slurry mixture is pumped through the pipeline at or above a critical velocity.

19. The crude oil-hydrate slurry mixture of claim 18 wherein the water comprises ocean water.

20. The crude oil-hydrate slurry mixture of claim 18 wherein water is present in the crude oil-hydrate slurry mixture in an amount of at least 50 wt %.
